(19) United States
(12) Patent Application Publication
(10) Pub. No.: US 2015/0292721 A1
(43) Pub. Date: Oct. 15, 2015

(54) Flexible Illumination Device and Method

(71) Applicants: John D. Lesmeister, Bartlett, IL (US); Charles Siegerdt, Roselle, IL (US)

(72) Inventors: John D. Lesmeister, Bartlett, IL (US); Charles Siegerdt, Roselle, IL (US)

(21) Appl. No.: 14/681,709

(22) Filed: Apr. 8, 2015

Related U.S. Application Data
(60) Provisional application No. 61/977,157, filed on Apr. 9, 2014.

(51) Int. Cl. F21V 21/32; F21V 14/02; F21V 8/00; F21L 4/08

(52) U.S. Cl. CPC F21V 21/32; F21L 4/085; F21V 14/025; G02B 6/0096; F21W 2111/10

(57) ABSTRACT

An illuminating device includes a handle portion. The device includes a power source. The device further includes a tube construction comprising a bendable ductile member extending within a cavity thereof. A light source comprises a plurality of light emitting devices in the cavity of the tube construction. The light emitted from the light source is visible along the tube construction.

### CROSS-REFERENCE TO RELATED APPLICATIONS

This application is the nonprovisional application of the provisional application Ser. No. 61/977,157, filed on Apr. 9, 2014, of which the disclosure thereof is incorporated by reference in its entirety.

### FIELD OF THE INVENTION

The present invention generally relates to an illumination device. More particularly, the present invention relates to a flexible shaft illumination device illuminatable radially outwardly along the length of the flexible shaft as well as from the 20 tip of the flexible shaft to be used as an inspection tool.

### BACKGROUND

U.S. Pat. No. 3,111,277 ('277 patent), which issued to Grimsley, discloses a Portable Electric Flashlight. The '277 patent describes a portable electric flashlight comprising a rigid casing, carrying at least one battery therein and having a switch convenient to the user of such flashlight mounted thereon and controlling the circuit of said battery, said casing having threads at an end thereof, a threaded electrically nonconductive cap screwed on the front end of the casing, said cap having an opening therethrough; an electrically conductive rigid tube having an end located in said cap and 5 rigidly secured to the cap; and means electrically connecting the tube to a pole of said battery.

An electrically conductive manually deformable self-form-maintaining tube is secured to the front end of the rigid tube; a single flexible lead extending through both said tubes and being electrically connected to the other pole of the battery; a socket including an electrically conductive rigid tube rigidly and electrically connected to the front end of the flexible tube and a central electrical contact rigidly carried by and insulated from the tube and electrically connected to the front end of the flexible lead; a light bulb in said socket; and a protective sleeve enclosing a major portion of said socket and of said light bulb, said sleeve being of lesser cross-section than the cross-section of the rigid casing and in the order of the cross-section of the manually deformable tube.

U.S. Pat. No. 3,881,468 ('468 patent), which issued to Foltz, discloses a Flex Light. The '468 patent essentially describes a flexible surgical light for use in illuminating various body cavities during surgery comprising a housing configured to house a voltage source therein and having a first conductor means formed thereon, an extended bulb assembly mounted on one end of the housing and a switch means mounted on the opposite end of the housing, the extended bulb assembly comprises an elongated hollow sleeve having mounting means attached on one end thereof to attach the extended bulb assembly to the housing and a bulb housing having a light source disposed therein attached to the opposite end thereof. A second conductor means is disposed within the hollow sleeve being coupled to a portion of the light source and a third conductor means extending substantially the entire length of the hollow sleeve coupled to another portion of the light source. The switch means is movable to operatively engage the first conductor means to selectively close the circuit and activate the light source.

U.S. Pat. No. 5,154,483 ('483 patent), which issued to Zeller, discloses a Flashlight with Flexible Extension. The '483 patent describes a flashlight which comprises a housing adapted to accommodate batteries and an elongate extension having a proximal end connected to the housing and a distal end opposite the proximal end adapted to accommodate a light bulb. Electrically conductive leads carried by the extension are adapted to connect the battery to the bulb. The extension is formed of multiple strands of twisted copper wire or another material separate from the conductive leads that can be easily flexed by hand to assume a plurality of different shapes and that can retain a given shape indefinitely. The housing and the bulb can each be conveniently positioned and oriented independently of the other.

U.S. Pat. No. 6,004,004 ('004 patent), which issued to Altman et al., discloses a Portable Dual Flashlight Assembly with Elongated Deformable Body Member. The '004 patent describes a portable dual flashlight assembly includes a flexible and deformable elongated body member for wrapping and retaining the assembly around an object, a battery compartment mounted to each end of the body member and providing a source of electrical power at each end thereof, a light bulb enclosure mounted to each battery compartment, a light bulb mounted in each light bulb enclosure and generating a beam of light at one end of each battery compartment and a mechanism associated with each light bulb enclosure for switching each light bulb on and off. The deformable body member includes an elongated deformable member and a flexible tubular covering enclosing the deformable member. The flexible covering extends around and along the deformable member and has a longitudinal central channel receiving the wire therethrough.

U.S. Pat. No. 6,007,214 ('214 patent), which issued to Shiao, discloses an Illuminating Tool. The '214 patent describes an illuminating tool which includes a flexible core with head and tail end portions, and a pair of wires exposed from the end portions to form central and peripheral head contacts and central and peripheral tail contacts. A first socket member has a first neck end mounted on the tail end portion, and a first socket portion extending axially therefrom to form a proximate inner engaging wall relative to the tail end portion to enclose the central tail contact and a distal inner engaging wall connected conductively to the peripheral tail contact. A barrel housing defines a first axis and accommodates a battery. The barrel housing has a front end, an intermediate wall and a rear end in the form of a mounting seat. A switch member is operable externally along the first axis between a switch-on position, where electrical connection is established between a second electrode of the battery and the barrel housing, and a switch-off position. A bulb is received in a bulb seat that permits plugging and gripping of the head end portion of the flexible core to establish electrical connection between the bulb and the conductive wires.

U.S. Pat. No. 6,267,492 ('492 patent), which issued to Reid et al., discloses an Illumination Device with Side Emitting Light Guide. The '492 patent describes side emitting light guides which are provided in connection with illumination devices, light guide systems, and task light illumination kits. The side emitting light guides may provide bright directional light, or they may provide diffuse light. The side emitting light guides may be flexible to allow for insertion into tortuous passageways. The light guides may also have a relatively small profile and/or a solid core. The light guides may also include shades that allow an operator to convert the light guides from side emitting to end emitting in order to provide brighter, more focused illumination in a particular area to perform some tasks. When completed, the user has the option of re-configuring the light guides for side emission to provide general area illumination.

U.S. Pat. No. 6,491,408 ('408 patent), which issued to Cooper et al., discloses a Pen-Size Led Inspection Lamp for Detection of Flourescent Material. The '408 patent describes a pen-size inspection lamp for detecting fluorescent materials. The inspection lamp includes a lamp housing, an extendible handle, and at least one LED.

U.S. Pat. No. 6,874,908 ('908 patent), which issued to Sharrah et al., discloses a Flexible Bendable Flashlight. The '908 patent describes a flashlight which comprises a housing having, for example, a tapered portion and a hole at a forward end thereof with a flexible/bendable extension including a solid state light source extending through the hole at the forward end thereof. A switch, preferably in a tail cap, selectively connects the solid state light source and at least one battery in the housing in circuit for causing the solid state light source to produce light. The flexible extension preferably makes electrical contact with the housing and/or preferably includes an insulating cover having an end retained in the housing.

United States Patent Application No. 2003/0194189, authored by Grothe et al., describes an invention which concerns a light wand including a flashlight, a section of light transmitting flexible fiber optic having a plurality of slits along its length, and a 5 tubular coupling adapted to optimize the transmission of light from the flashlight to the fiber optic.

United States Patent Application No. 2004/0174703, authored by Tally, describes a flashlight which comprises a light source element connected to flexible lead wires powered by batteries in a tubular housing. The electrical connection provides series circuit and a special control button arrangement provides for closing or opening of the series circuit to the light element.

United States Patent Application No. 2013/0176711, authored by Bushee et al. describes a lightweight plastic baton which includes a hollow cylindrical body which telescopically supports a flexible cylindrical plastic baton shaft. One or more slideways support and concentrically center the baton shaft within the hollow body. A flashlight having a strobed light operating mode is coupled to the baton body to provide a less than lethal deterrent to a potential assailant. A radially movable elastic switch cover is mounted substantially flush with the outer surface of the flashlight to prevent inadvertent actuation of one of several selectable flashlight operating modes.

From a consideration of the foregoing art in particular, and the field of art generally, it will be seen that the prior art perceives a need for an illumination tool having an inner bendable ductile member surrounded by a light-transmissive sheath whereby a light source is helically wound around the bendable ductile member intermediate said member and the said sheath for enabling a user to selectively transmit light from the device as bent or shaped into whatever configuration is necessary given the target application, as summarized in more detail hereinafter.

### SUMMARY

The present invention essentially provides an illumination device and associated tool methodology for use as an inspection tool as may be exemplified by a vehicular mechanic's tool or the like. In other words, the illumination device according to the present invention is contemplated to be used in scenarios where illumination is required in cramped, light-obstructed spaces as may be exemplified by the contours of an engine compartment.

The illumination device according to the embodiments of the invention preferably comprises a handle portion; a power source; a flexible, elongate sheath member or tube construction; and a light source as may be exemplified by an LED light string having a plurality of Light-Emitting Diodes or LED's. The handle portion or assembly preferably comprises outer handle surfacing and inner handle surfacing. The outer handle surfacing interfaces between a user's hand and said illumination device as assembled. The inner handle surfacing defines a power-sourcing space, which power-sourcing space provides certain conduit for delivering power to the light source or LED light string and/or a handle-based LED arrangement from the power source as exemplified by batteries.

A distal handle end may preferably comprise a secondary light source exemplified by an LED arrangement so as to direct light in a (distal) direction away from user's hand as it engages the handle assembly or portion and enhance the overall illumination characteristics of the device.

The elongate sheath member or tube construction is preferably connected to the handle portion and comprises inner tube surfacing and outer tube surfacing. The inner tube surfacing defines a light source-receiving space. The light source is received within the light source-receiving space and is in communication with the power source or batteries. The tube construction may be provided in any number of lengths. The illumination device according to the present invention may further preferably comprise certain switch means or switching means for enabling a user to selectively deliver power from the power source to the light source for illuminating the light source. The switching means according to the present invention are believed exemplified by any number of state of the art manual switches.

Further, the illumination device according to the present invention may further comprise a battery-receiving compartment that defines the power-sourcing space. The battery-receiving compartment basically functions to receive and house the battery-based power source for selectively powering the light source via the switch means as exemplified by the manual switch(es). The battery-based power source is preferably rechargeable.

The rechargeable batteries may for example be recharged by directly plugging a rechargeable base into a wall socket via male plug conductors. Alternatively, the device may be used in combination with a rechargeable base, which base is mated to a recharging post. The rechargeable bases according to the present invention are essentially modified state of the art type rechargeable bases, and thus it is believed that the illumination device according to the present invention may be recharged in a manner very much akin to other state of the art recharging systems.

The tube construction is preferably flexible and translucent for enabling light from the light source to emanate through the material of the tube construction. Preferably, the outer tube surfacing may be corrugated. The corrugated outer tube surfacing enhances light transmission therefrom by diffusing light from the contoured and corrugated outer tube surfacing as generally depicted at diffused light emissions.

A first tip construction preferably comprises certain means for focusing light into a narrow beam as may be exemplified by a tip aperture. A second tip construction comprises a clear or translucent material for diffusing light. Further, certain select outer surfacing portions may preferably comprise luminescent or glow-in-the-dark material(s) for enabling the user to illuminate adjacent areas when the power source is depleted or when there is no power.

The illumination device according to the present invention further preferably comprises a bendable ductile member. The bendable ductile member extends within the light source-receiving space, and enables to user to shape the tubular construction as required. In a preferred embodiment, the light source of the illumination device is wound helically round the bendable ductile member.

The illumination device according to the present invention may further preferably comprise certain object-grabbing means, which object-grabbing means are outfitted upon a distal end of the tubular construction for enabling a user to grab select objects via the distal end.

The object-grabbing means may preferably comprise certain magnetic object-grabbing means, the magnetic object-grabbing means for enabling a user to grab select objects via magnetic attraction forces. In this regard the magnetic object-grabbing means may be exemplified by a magnet for grabbing or magnetically attracting metallic objects as exemplified by a bolt. The object-grabbing means may further preferably comprise certain hook-based object-grabbing means, which object-grabbing means enable a user to grab select looped objects as exemplified by a nut via a hook.

### BRIEF DESCRIPTION OF THE DRAWINGS

Other features of our invention will become more evident from a consideration of the following brief descriptions of preliminary drawings of the subject invention(s):

FIG. 1 is a top perspective view of a first embodiment of the illumination device according to the present invention showing a first handle construction and a first distal tip construction.

FIG. 1A is an enlarged, fragmentary longitudinal sectional view of the distal tip or end of the illumination device otherwise depicted in FIG. 1.

FIG. 1B is an enlarged, fragmentary longitudinal sectional view of a linearly straight or unbent section of the illumination device otherwise depicted in FIG. 1.

FIG. 1C is an enlarged, fragmentary longitudinal sectional view of a linearly straight or unbent section of the illumination device otherwise depicted in FIG. 1.

FIG. 1D is a further enlarged, fragmentary longitudinal sectional view of the corrugated outer surfacing of the tube construction of the illumination device as otherwise depicted in FIG. 1B.

FIG. 2 is a top perspective view of a second embodiment of the illumination device according to the present invention showing a second handle construction and a second distal tip construction.

FIG. 2A is an enlarged, fragmentary longitudinal sectional view of a linearly straight or unbent section of the illumination device otherwise depicted in FIG. 2.

FIG. 2B is an enlarged, fragmentary depiction of the second tip construction according to the present invention magnetically holding a bolt aloft.

FIG. 2C is an enlarged, fragmentary depiction of the second tip construction according to the present invention holding a nut aloft via a hook member.

FIG. 2D is an enlarged, fragmentary depiction of a third tip construction according to the present invention showing a tip aperture for narrowing a light beam emitting from the tip construction.

FIG. 3 is a top perspective view of a third embodiment of the illumination device according to the present invention showing a third handle construction and the second distal tip construction.

FIG. 3A is an enlarged, fragmentary longitudinal sectional view of a linearly straight or unbent section of the illumination device otherwise depicted in FIG. 3.

FIG. 3B is an enlarged, fragmentary depiction of the second tip construction according to the present invention magnetically holding a bolt aloft.

FIG. 3C is an enlarged, fragmentary depiction of the second tip construction according to the present invention holding a nut aloft via a hook member.

FIG. 4 is a fragmentary side view of the second embodiment of the illumination device according to the present invention showing a partial handle construction, the second distal tip construction, and a first relatively short tube construction length.

FIG. 4A is a fragmentary side view of the second embodiment of the illumination device according to the present invention showing a partial handle construction, the second distal tip construction, and a second intermediate tube construction length.

FIG. 4B is a fragmentary side view of the second embodiment of the illumination device according to the present invention showing a partial handle construction, the second distal tip construction, and a third relatively long tube construction length.

FIG. 4C is a transverse view of a distal handle end of the partial handle construction otherwise shown in FIG. 4.

FIG. 4D is an enlarged, fragmentary longitudinal sectional view of a linearly straight or unbent section of the illumination device otherwise depicted in FIG. 4.

FIG. 5 is a top perspective view of a fourth embodiment of the illumination device according to the present invention showing a fourth handle construction and the 5 second distal tip construction.

FIG. 5A is an enlarged, fragmentary longitudinal sectional view of a linearly straight or unbent section of the illumination device otherwise depicted in FIG. 5.

FIG. 5B is an enlarged, fragmentary depiction of the second tip construction according to the present invention magnetically holding a bolt aloft.

FIG. 5C is an enlarged, fragmentary depiction of the second tip construction according to the present invention holding a nut aloft via a hook member.

FIG. 6 is a top perspective view of a fifth embodiment of the illumination device according to the present invention showing a fourth handle construction and the second distal tip construction.

FIG. 6A is an enlarged, fragmentary longitudinal sectional view of a linearly straight or unbent section of the illumination device otherwise depicted in FIG. 6.

FIG. 6B is an enlarged, fragmentary depiction of the second tip construction according to the present invention magnetically holding a bolt aloft.

FIG. 6C is an enlarged, fragmentary depiction of the second tip construction according to the present invention holding a nut aloft via a hook member.

### DETAILED DESCRIPTION

Referring now to the drawings now with more specificity, the present invention basically provides an illumination device as at 10 and associated tool methodology for use as an inspection tool as may be exemplified by a vehicular mechanic's tool or the like. In other words, the illumination device 10 according to the present invention is contemplated to be used in scenarios where illumination is required in cramped, light-obstructed spaces as may be exemplified by the contours of an engine compartment.

The illumination device 10 according to the embodiments of the invention preferably comprises a handle portion as at 11; a power source as generically depicted by at least one battery as at 12; a flexible, elongate sheath member or tube construction as at 13; and a light source as may be exemplified by an LED light string as at 14, having a plurality of LED's as at 24.

The handle portion or assembly 11 preferably comprises outer handle surfacing 15 and inner handle surfacing. The outer handle surfacing 15 interfaces between a user's hand and said illumination device 10 as assembled. The inner handle surfacing defines a power-sourcing space, which power-sourcing space provides certain conduit for delivering power to the light source or LED light string 14 and/or a handle-based LED arrangement as at 35 from the power source as exemplified by batteries 12.

In this regard, it is contemplated that a distal handle end 36 may preferably comprise a secondary light source exemplified by LED arrangement 35 so as to direct light in a direction as at 109 away from user's hand as it engages the handle assembly 11 and enhance the illumination characteristics of the device 10.

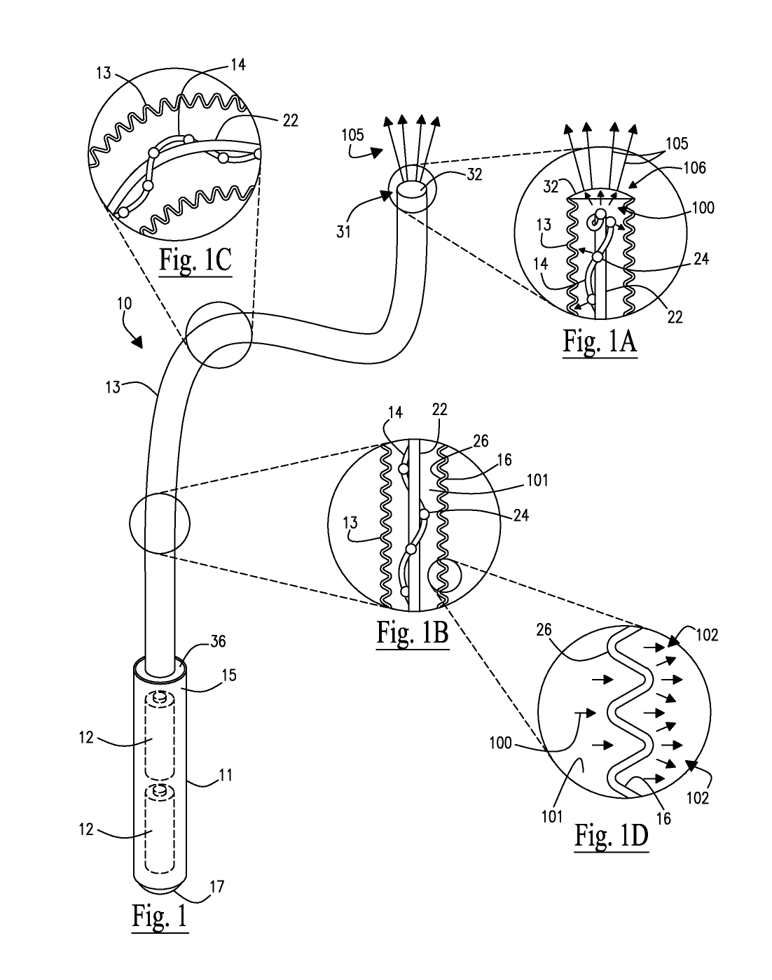

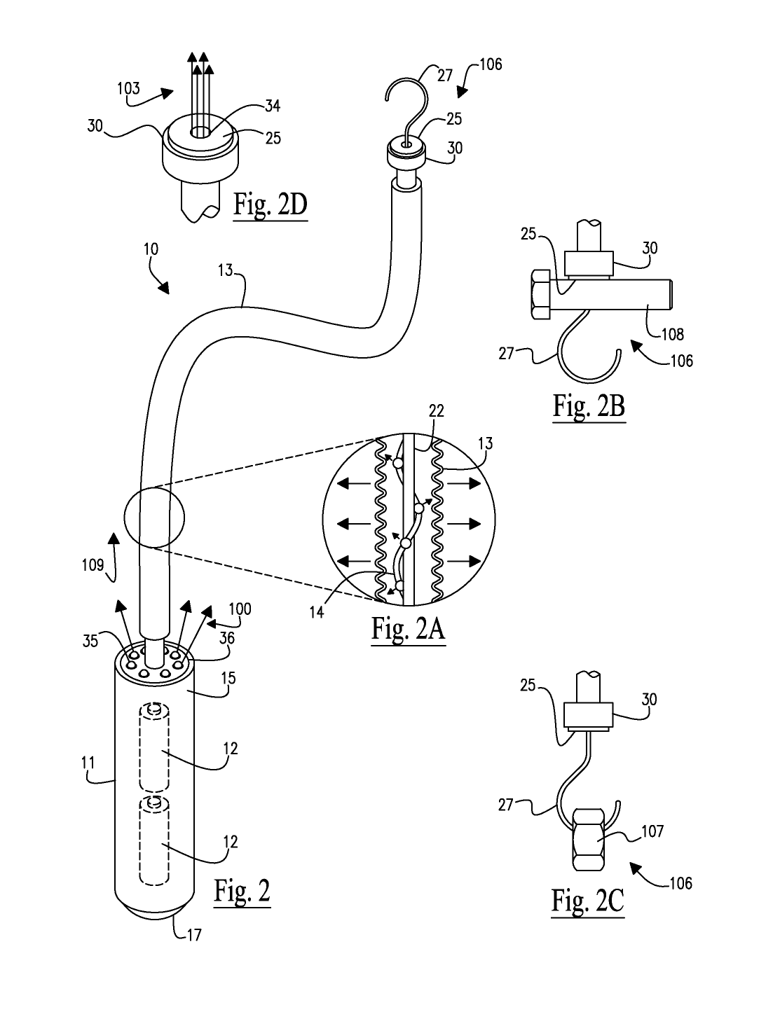

FIG. 1 depicts a first type of handle portion 11 having a relatively small diameter for coaxially receiving two AA type batteries 12. FIG. 2 depicts a second type of handle portion 11 having a relatively large diameter (as opposed to the first type of handle portion) for coaxially receiving two AA type batteries 12, but including an LED arrangement 35.

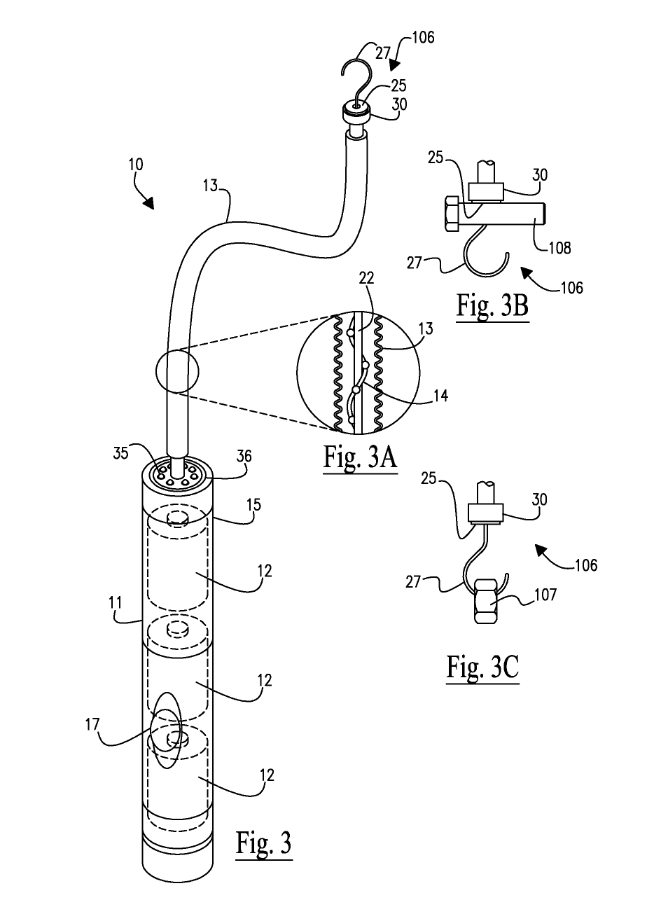

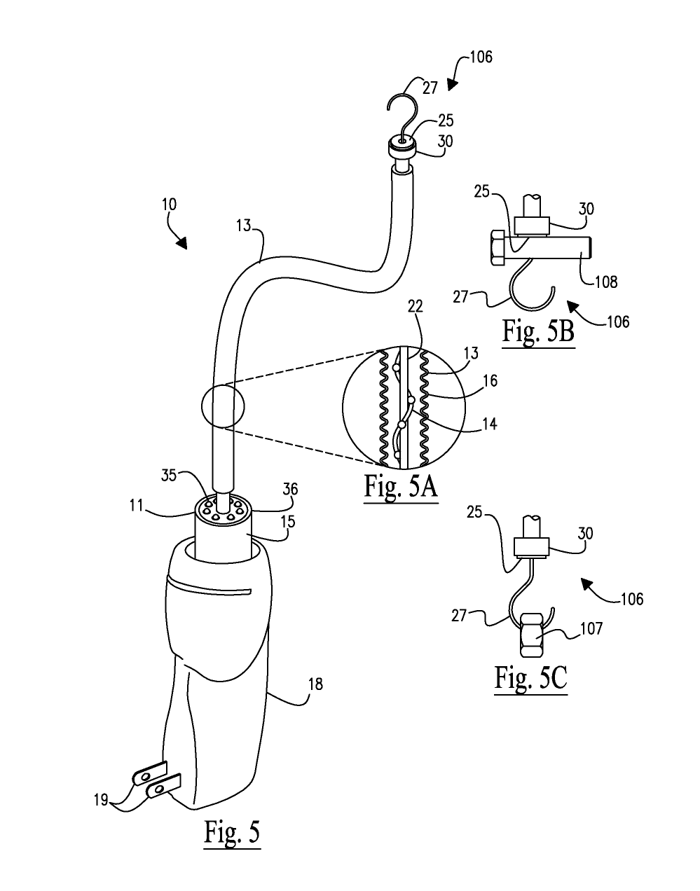

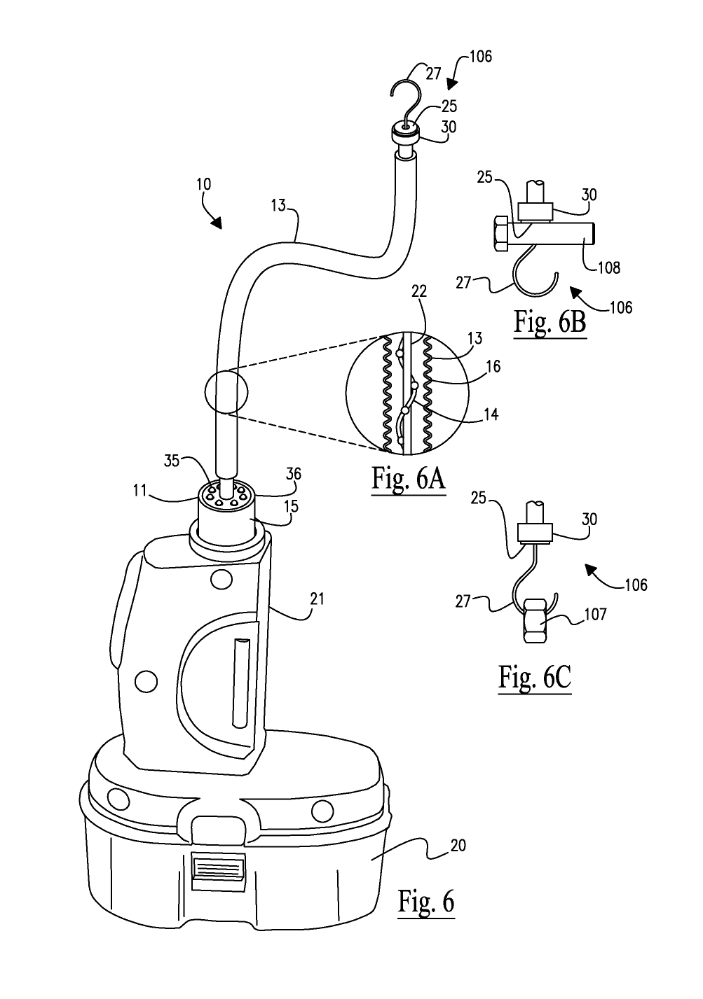

FIG. 3 depicts a third type of handle portion 11 having a diameter substantially equal to the diameter of the second type of handle portion for coaxially receiving three C type batteries 12. FIG. 5 depicts a fourth type of handle portion 11 that mates with a first type of rechargeable base as at 18, which base 18 plugs in to a wall outlet via male plugs 19. FIG. 6 depicts a fifth type of handle portion 11 that 10 mates with a second (e.g. DeWalt) type of rechargeable base as at 20 and base post 21.

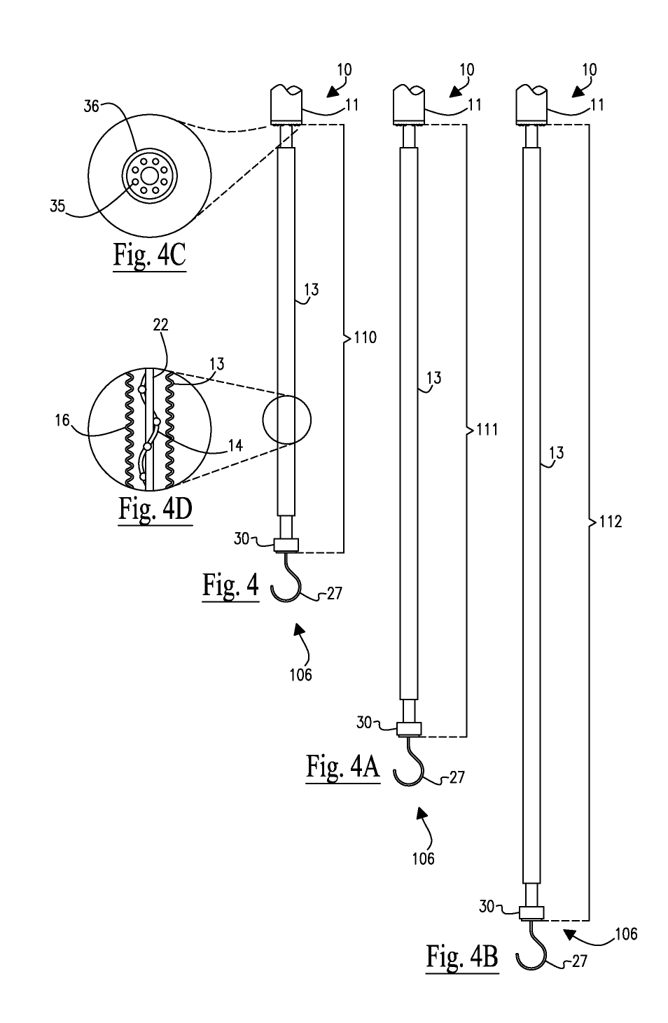

The elongate sheath member or tube construction 13 is preferably connected to the handle portion 11 and comprises inner tube surfacing as at 26 and outer tube surfacing as at 16. The inner tube surfacing 26 defines a light source-receiving space as at 101. The light source 14 is received within the light source-receiving space 101 and is in communication with the power source or batteries 12. The tube construction 13 may be provided in any number of lengths. Referencing FIGS. 4, 4A, and 4B, the reader will see a relatively short tube length as at 110, an intermediate tube length as at 111, and a relatively long tube length as at 112.

The illumination device 10 according to the present invention may further preferably comprise certain switch means or switching means for enabling a user to selectively deliver power from the power source 12 to the light source 14 for illuminating the light source. The switching means according to the present invention are believed exemplified by any number of state of the art manual switches as at 17.

Further, the illumination device 10 according to the present invention may further comprise a battery-receiving compartment that defines the power-sourcing space. The battery-receiving compartment basically functions to receive and house the battery-based power source 12 for selectively powering the light source 14 via the switch means as exemplified by the manual switch(es) 17. The battery-based power source is preferably rechargeable. Referencing FIGS. 5 and 6, the reader will there see various exemplary means for recharging batteries 12 as received in the handle assembly 11.

The rechargeable batteries may for example be recharged by directly plugging a rechargeable base as at 18 into a wall socket via male plug conductors 19. Alternatively, the device may be used in combination with a rechargeable base as at 20, which base is mated to a recharging post as at 21. The rechargeable bases 18 and 20 are state of the art type rechargeable bases, and thus it is believed that the illumination device 10 according to the present invention may be recharged in a manner very much akin to other state of the art recharging systems as exemplified by bases 18 and 20.

The tube construction 13 is preferably flexible and translucent for enabling light from the light source 14 to emanate as at 100 through the material of the tube construction 13. Preferably, the outer tube surfacing 16 may be corrugated. The corrugated outer tube surfacing 16 enhances light transmission therefrom by diffusing light from the contoured and corrugated outer tube surfacing 16 as generally depicted at diffused light emissions 102.

The tip construction as at 30 preferably comprises certain means for focusing light into a narrow beam as at 103 as may be exemplified by a tip aperture as at 34. The tip construction 31 comprises a clear or translucent material as at 32 for diffusing light as at 105. Further, certain select outer surfacing portions as at 33 may preferably comprise luminescent or glow-in-the-dark material(s) for enabling the user to illuminate adjacent 5 areas when the power source is depleted or when there is no power.

The illumination device 10 according to the present invention further preferably comprises a bendable ductile member as at 22. For example, the bendable ductile member 22 comprises a semi-flexible metallic material, such as copper or other bi-metals (alloys). As such, the bendable ductile member 22 permits repeat bending or flexible without structural damage or deterioration. In one embodiment, the bendable ductile member 22 may be a solid copper wire with or without insulation being about 12 inches long and about 12 gauge. It is to be understood other metals and sizes may be used without departing from the scope and spirit of the invention.

The bendable ductile member 22 extends within the light source-receiving space, and enables to user to shape the tubular construction 13 as required. FIGS. 1, 2, 3, 5, and 6 depict the device 10 selectively bent as at 104 into the desired shape. In a preferred embodiment, the light source 14 of the illumination device 10 is wound helically round the bendable ductile member 22 as further generally depicted in FIGS. 1A, 1B, 1C, 2A, 3A, 4D, 5A, and 6A.

The illumination device 10 according to the present invention may further preferably comprise certain object-grabbing means, which object-grabbing means are outfitted upon a distal end 106 of the tubular construction 13 for enabling a user to grab select objects via the distal end 106.

The object-grabbing means may preferably comprise certain magnetic object-grabbing means, the magnetic object-grabbing means for enabling a user to grab select objects via magnetic attraction forces. In this regard the magnetic object-grabbing means may be exemplified by a magnet as at 25 for grabbing or magnetically attracting metallic objects as exemplified by a bolt as at 108. The object-grabbing means may further preferably comprise certain hook-based object-grabbing means, which object-grabbing means enable a user to grab select looped objects as exemplified by a nut 107 via a hook as at 27.

While the foregoing sets forth much specificity, the foregoing should not be construed as setting forth limitations on the present invention, but as setting forth certain preferred embodiments. For example, it is contemplated that the present invention essentially provides an illumination device for use as an inspection tool. The illumination device according to the present invention is believed to essentially comprise a handle portion, a power source, a tube construction, and a light source.

The handle portion preferably comprises outer handle surfacing and inner handle surfacing. The outer handle surfacing interfaces between a user's hand and said illumination device 10. The inner handle surfacing defines a power-sourcing space, which power-sourcing space provides certain power delivery conduit.

The power source delivers power via the power-sourcing space to the light source housed within the tube construction. The tube construction is connected to the handle portion, and comprises inner tube surfacing and outer tube surfacing. The inner tube surfacing defines a light source-receiving space in which space the light source extends and is in electrical communication with the power source.

In addition the various structural specifications outlined hereinabove, it is further contemplated that the present invention supports certain illumination tool methodology. The illumination tool method according to the present invention is believed to essentially comprise the steps of: providing an illumination device, the illumination device comprising a handle portion, a power source, an elongate sheath member, and a light source; defining a power-sourcing space via inner handle surfacing, the inner handle surfacing defining a power-sourcing space, the power-sourcing space providing power delivery conduit; interfacing a user's hand with said illumination device via outer handle surfacing; delivering power via the power-sourcing space and the power source to the light source; and providing illumination along the elongate sheath member via the light source.

Accordingly, although the invention has been described by reference to certain preferred embodiments and certain methodology, it is not intended that the novel arrangements or methods be limited thereby, but that modifications thereof are intended to be included as falling within the broad scope and spirit of the foregoing disclosures, following provisionally drafted claims, and the appended drawings.

Moreover the following examples are illustrative of aspects of the invention:

1. A illumination device for use as an inspection tool, the illumination device comprising:

a handle portion, the handle portion comprising outer handle surfacing and inner handle surfacing, the outer handle surfacing for interfacing between a hand of a user and said illumination device, the inner handle surfacing defining a power-sourcing space, the power-sourcing space for providing power delivery conduit;

a power source, the power source for delivering power via the power-sourcing space;

a tube construction connected to the handle portion, the tube construction comprising inner tube surfacing and outer tube surfacing, the inner tube surfacing defining a light source-receiving space; and

a light source, the light source being in communication with the power source and extending within the light source-receiving space.

2. The illumination device of claim 1 comprising switch means, the switch means for enabling a user to selectively deliver power to the light source for illuminating said light source.

3. The illumination device of claim 2 wherein the power-sourcing space defines a battery-receiving compartment, the battery-receiving compartment for receiving and housing a battery-based power source for selectively powering the light source via switch means.

4. The illumination device of claim 3 wherein the battery-based power source is rechargeable.

5. The illumination device of claim 1 wherein the tube construction is flexible.

6. The illumination device of claim 5 wherein the tube construction is translucent for enabling light from the light source to emanate through the material of the tube construction.

7. The illumination device of claim 6 wherein the outer tube surfacing is corrugated, the corrugated outer tube surfacing for enhancing light transmission therefrom.

8. The illumination device of claim 1 comprising a bendable ductile member, the bendable ductile member extending within the light source-receiving space, and enabling to user to shape the tubular construction as required.

9. The illumination device of claim 8 wherein the light source is wound helically round the bendable ductile member.

10. The illumination device of claim 9 wherein the light source is defined by a LED light string.

11. The illumination device of claim 1 comprising object-grabbing means, the object-grabbing means being outfitted upon a distal end of the tubular construction for enabling a user to grab select objects via the distal end.

12. The illumination device of claim 11 wherein the object-grabbing means comprise magnetic object-grabbing means, the magnetic object-grabbing means for enabling a user to grab select objects via magnetic attraction forces.

13. The illumination device of claim 11 wherein the object-grabbing means comprise hook-based object-grabbing means, the object-grabbing means for enabling a user to grab select looped objects.

14. The illumination device of claim 1 wherein select outer surfacing portions of said device comprise luminescent materials.

15. The illumination device of claim 1 wherein a distal end of the device is outfitted with means for focusing the light beam emanating therefrom.

16. The illumination device of claim 1 wherein the handle portion comprises outlet-engagement means, the outlet engagement means being in electrical communication with the batter-based power source and enabling the user to plug-in the handle portion.

17. The illumination device of claim 1 wherein the handle portion comprises means for receiving a recharging post, the means for receiving a recharging post being matable with a recharging post for recharging the battery-based power source.

18. The illumination device of claim 1 wherein the handle portion comprises a distal handle end, the distal handle end being outfitted with a second light source for enhancing illumination from said illumination device.

19. A illumination tool method, the illumination tool method comprising the steps of:

providing an illumination device, the illumination device comprising a handle portion, a power source, an elongate sheath member, and a light source;

defining a power-sourcing space via inner handle surfacing, the inner handle surfacing defining a power-sourcing space, the power-sourcing space providing power delivery conduit;

interfacing a user's hand with said illumination device via outer handle surfacing;

delivering power via the power-sourcing space and the power source to the light source; and

providing illumination along the elongate sheath member via the light source.

20. The illumination tool method of claim 19 comprising the step of selectively delivering power to the light source for illuminating said light source via switch means.

21. The illumination tool method of claim 20 comprising the steps of receiving and housing a battery-based power source with a power-sourcing space of the handle for selectively powering the light source via said switch means.

22. The illumination tool method of claim 21 comprising the step of recharging the battery-based power source.

23. The illumination tool method of claim 19 comprising the step of flexing the elongate sheath member.

24. The illumination tool method of claim 19 comprising the step of transmitting light radially outwardly from the elongate sheath member.

25. The illumination tool method of claim 24 comprising the step of redirecting the radially outwardly transmitted light via corrugated material construction of the elongate sheath member.

26. The illumination tool method of claim 19 comprising the step of shaping the elongate sheath member as required via an inner bendable ductile member, the bendable ductile member extending within the elongate sheath member.

27. The illumination tool method of claim 26 comprising the step of helically winding the light source round the bendable ductile member.

28. The illumination tool method of claim 19 comprising the step of grabbing select objects via a distal end of the elongate sheath member via object-grabbing means.

29. The illumination tool method of claim 28 comprising the step of magnetically attracting select objects via magnetic object-grabbing means.

30. The illumination tool method of claim 28 comprising the step of hook-grabbing select looped objects via hooked object-grabbing means.

31. The illumination tool method of claim 19 comprising the step of illuminating select objects via luminescent materials outfitted upon select outer surfacing of the illumination device.

32. The illumination tool method of claim 19 comprising the step of focusing light from the light source via focusing means outfitted upon a distal end of the elongate sheath member.

33. The illumination tool method of claim 19 comprising the step of directing light in a distal direction from a distal handle end while simultaneously directing light outwardly from the light source via the elongate sheath member.

We claim:

1. An illumination device comprising:
a power source;
a tube construction defining a cavity;
a bendable ductile member having one end connected to a handle portion, the bendable ductile member enclosed within the cavity of the tube construction; and
a light source comprising a plurality of light emitting devices in the cavity of the tube construction, wherein light emitted from the plurality of light emitting devices is visible through the tube construction.

2. The illumination device of claim 1, wherein the light source comprising a spotlight disposed at a distal end of the bendable ductile member.

3. The illumination device of claim 1, further comprising a cap fitted on a distal end of the tube construction.

4. The illumination device of claim 3, wherein the cap comprises an opening transmitting light from the spotlight.

5. The illumination device of claim 3, wherein the cap comprises a magnetic tip.

6. The illumination device of claim 5, further comprising one or more metallic objects magnetically attached to the magnetic tip of the cap.

7. The illumination device of claim 1, wherein the power source comprises a rechargeable battery.

8. The illumination device of claim 1, wherein the tube construction is flexible relative to the bendable ductile member.

9. The illumination device of claim 1, wherein the tube construction is translucent for enabling light from the light source to emanate through the tube construction.

10. A lighting device comprising:
a power source;
a tube construction defining a cavity, the tube construction comprising a corrugated outer surface;
a bendable ductile member having one end connected to a handle portion, the bendable ductile member enclosed within the cavity of the tube construction; and
a light source comprising a plurality of light emitting devices in the cavity of the tube construction, wherein light emitted from the plurality of light emitting devices is visible through the tube construction.

11. The lighting device of claim 10, wherein the plurality of light emitting devices is helically wound the bendable ductile member.

12. The lighting device of claim 10, wherein the plurality of light emitting devices comprises a LED light string.

13. The lighting device of claim 10, wherein the light source comprising a spotlight disposed at a distal end of the bendable ductile member.

14. The lighting device of claim 10, further comprising a cap fitted on a distal end of the tube construction.

15. The lighting device of claim 14, wherein the cap comprises an opening transmitting light from the spotlight.

16. The lighting device of claim 14, wherein the cap comprises a magnetic tip.

17. The lighting device of claim 16, further comprising one or more metallic objects magnetically attached to the magnetic tip of the cap.

18. The lighting device of claim 1, wherein the tube construction is flexible relative to the bendable ductile member.

19. The lighting device of claim 1, wherein the tube construction is translucent for enabling light from the light source to emanate through the tube construction.

20. A lighting device comprising:
a power source;
a tube construction defining a cavity, the tube construction comprising a corrugated outer surface;
a bendable ductile member having one end connected to a handle portion, the bendable ductile member enclosed within the cavity of the tube construction;
a light source comprising a spotlight and a plurality of light emitting devices in the cavity of the tube construction, wherein light emitted from the plurality of light emitting devices is visible through the tube construction, wherein the spotlight is disposed on a distal end of the bendable ductile member for emitting light from the distal end of the bendable ductile member; and
wherein the tube construction is flexible relative to the bendable ductile member.
